(19) United States
(12) Patent Application Publication
(10) Pub. No.: US 2011/0260048 A1
(43) Pub. Date: Oct. 27, 2011

(54) Ion Transfer Tube for a Mass Spectrometer Having a Resistive Tube Member and a Conductive Tube Member

(76) Inventors: Eloy R. WOUTERS, San Jose, CA (US); Alexander A. Makarov, Bremen (DE); Jean-Jacques Dunyach, San Jose, CA (US)

(21) Appl. No.: 12/765,540

(22) Filed: Apr. 22, 2010

(51) Int. Cl. H01J 49/04; H01J 49/26

(52) U.S. Cl. 250/282; 250/288

(57) ABSTRACT

An ion transfer tube having an ion inlet and an ion outlet comprises: a first tube member comprising an electrically resistive material and having a first end comprising the ion inlet and a second end; a first electrode electrically coupled to the first tube member; a second tube member having a first end in leak-tight contact with the second end of the first tube member and a second end comprising the ion outlet; a second electrode electrically coupled to either the first tube member or the second tube member; and a heater thermally coupled to at least one of the tube members, wherein, in operation, an electrical potential difference applied between the electrodes produces an electric field within the first tube member that urges charged particles through the first tube member into the second tube member and the heater supplies heat to the charged particles within the ion transfer tube.

### FIELD OF THE INVENTION

This invention generally relates to mass spectrometer systems, and more specifically to an ion transfer tube for transporting ions between regions of different pressure in a mass spectrometer.

### BACKGROUND OF THE INVENTION

Ion transfer tubes are well-known in the mass spectrometry art for transporting ions from an ionization chamber, which typically operates at or near atmospheric pressure, to a region of reduced pressure. Generally described, an ion transfer tube typically consists of a narrow elongated conduit having an inlet end open to the ionization chamber, and an outlet end open to the reduced-pressure region. Ions formed in the ionization chamber (e.g., via an electrospray ionization (ESI) or atmospheric pressure chemical ionization (APCI) process), together with partially desolvated droplets and background gas, enter the inlet end of the ion transfer tube, traverse its length under the influence of the pressure gradient, and exit the outlet end into a lower-pressure chamber—often, the first vacuum stage of a mass spectrometer. The ions subsequently pass through apertures in one or more partitions, such apertures possibly in skimmer cones, through regions of successively lower pressures and are thereafter delivered to a mass analyzer for acquisition of a mass spectrum.

It is known in the art that the transport of ions from an atmospheric pressure ion source to the first vacuum stage of a mass spectrometer through an ion transfer tube is not very efficient: the majority of the ions will not be transmitted. Various theories point at different places were the loss occurs and different mechanisms for the lack of ion transmission, such as atmospheric pressure, the solvated ions need to escape the droplets, evaporating droplets with Coulomb explosions repelling ions away from the inlet of the mass spectrometer etc. Various ways to improve the ion transmission have been proposed.

The use of tubes made of so called “resistive glass” has been proposed as an alternative means of providing an electric field along the tube axis (for instance, see U.S. Pat. No. 5,736,740, “Method and device for transport of ions in gas through a capillary” in the name of inventor Franzen). In the Franzen invention, the electric field is used to slow down the ions by applying a gradient reversely biased with respect to the propagation direction of the ions of a certain polarity. Please note that the current disclosure (and also the patent of Willoughby and Sheehan) has an electric field opposite to that taught by Franzen.

Another proposal for reducing the entrance losses of ions into an ion transfer tube at atmospheric pressure has been put forth in U.S. Pat. No. 6,943,347 in the names of inventors Willoughby and Sheehan. In the Willoughby and Sheehan invention the commonly-used metal tube is replaced with a stack of laminated sheets of alternating layers of dielectric and metal electrodes with a lumen or bore provided through the stack. The metal electrode sheets may be energized at different voltages by a power supply so as to create a potential gradient along the bore created through the stack. The potential gradient created by the electrode stack replaces the field-free region within a metal tube, and the entrance loss due to the dispersive fields at the entrance of the tube said to be avoided.

### SUMMARY OF THE INVENTION

An ion transfer tube for introducing ions from an atmospheric pressure ion source into the first vacuum stage of a mass spectrometer with reduced entrance losses is disclosed. The novel ion transfer tube comprises two tube-member segments with a leak-tight seal therebetween. A first tube-member segment at the entrance end of the ion transfer tube comprises a resistive material and a second tube-member segment comprises a material that conducts heat very well, such as a metal. A first electrical potential is applied to the entrance side of the first tube member and a second electrical potential is applied to either the other end of the first tube member or to the second tube member, such that an electric field is created within the first tube member so as to at least partially urge the ions into or accelerate ions through the ion transfer tube, thereby reducing entrance losses. Electrodes are provided so as to provide the electrical potential difference across the length of the first tube member.

### BRIEF DESCRIPTION OF THE DRAWINGS

The above noted and various other aspects of the present invention will become apparent from the following description which is given by way of example only and with reference to the accompanying drawings, not drawn to scale, in which:

FIG. 1 is a schematic illustration of a first example of a generalized conventional mass spectrometer system comprising an ion transfer tube;

FIG. 2 is a schematic illustration of a portion of a known ion transfer tube in both cross-sectional and perspective views;

FIG. 3A is a schematic cross sectional view of an ion transfer tube in accordance with various embodiments of the instant teachings;

FIG. 3B is a schematic cross sectional view of a modified version of the ion transfer tube of FIG. 3A in accordance with various embodiments of the instant teachings;

FIG. 4A is a schematic cross sectional view of another ion transfer tube in accordance with various embodiments of the instant teachings;

FIG. 4B is a schematic cross sectional view of a modified version of the ion transfer tube of FIG. 4A in accordance with various embodiments of the instant teachings;

FIG. 5A is a schematic cross sectional view of still another ion transfer tube in accordance with various embodiments of the instant teachings;

FIG. 5B is a schematic cross sectional view of a modified version of the ion transfer tube of FIG. 5A in accordance with various embodiments of the instant teachings;

FIG. 5C is a schematic cross sectional view of another modified version of the ion transfer tube of FIG. 5A in accordance with various embodiments of the instant teachings;

FIG. 6 is a schematic view of a mass spectrometer system in accordance with various embodiments of the instant teachings; and

FIG. 7 is a flowchart of a method for analyzing ions in a mass spectrometer apparatus in accordance with the instant teachings.

### DETAILED DESCRIPTION

The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described.

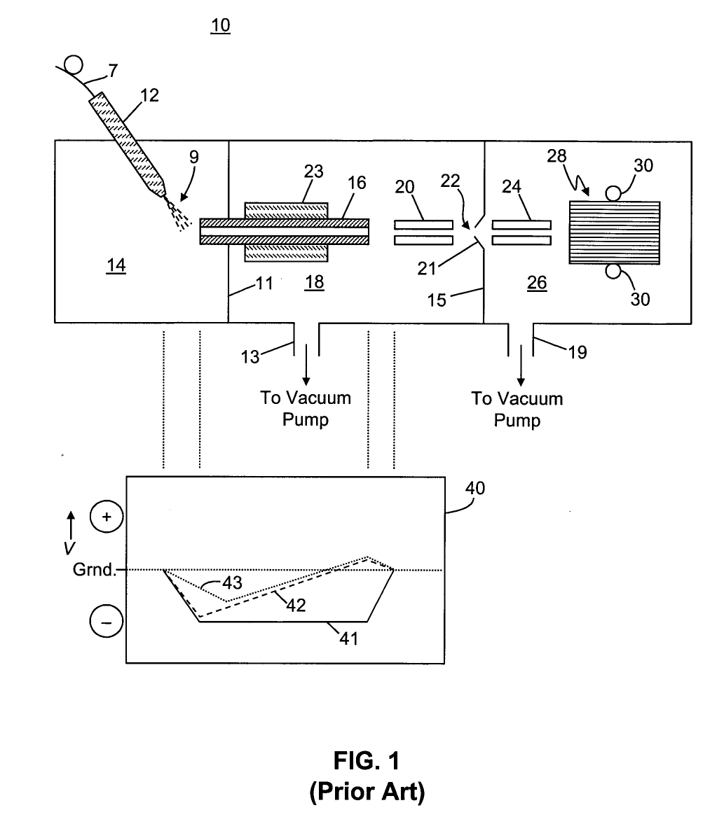

To more particularly describe the features of the present invention, please refer to FIGS. 1 through 7 in conjunction with the discussion below.

FIG. 1 is a simplified schematic diagram of a general conventional mass spectrometer system comprising an atmospheric pressure ionization (API) source coupled to an analyzing region via an ion transfer tube. Referring to FIG. 1, an API source 12 housed in an ionization chamber 14 is connected to receive a liquid sample from an associated apparatus such as for instance a liquid chromatograph or syringe pump through a capillary 7. The API source 12 optionally is an electrospray ionization (ESI) source, a heated electrospray ionization (H-ESI) source, an atmospheric pressure chemical ionization (APCI) source, an atmospheric pressure matrix assisted laser desorption (MALDI) source, a photoionization source, or a source employing any other ionization technique that operates at pressures substantially above the operating pressure of mass analyzer 28 (e.g., from about 1 ton to about 2000 ton). Furthermore, the term API source is intended to include a “multi-mode” source combining a plurality of the above-mentioned source types. The API source 12 forms charged particles 9 (either ions or charged droplets that may be desolvated so as to release ions) representative of the sample, which charged particles are subsequently transported from the API source 12 to the mass analyzer 28 in high-vacuum chamber 26 through at least one intermediate-vacuum chamber 18. In particular, the droplets or ions are entrained in a background gas and transported from the API source 12 through an ion transfer tube 16 that passes through a first partition element or wall 11 into an intermediate-vacuum chamber 18 which is maintained at a lower pressure than the pressure of the ionization chamber 14 but at a higher pressure than the pressure of the high-vacuum chamber 26. The ion transfer tube 16 may be physically coupled to a heating element or block 23 that provides heat to the gas and entrained particles in the ion transfer tube so as to aid in desolvation of charged droplets so as to thereby release free ions.

Due to the differences in pressure between the ionization chamber 14 and the intermediate-vacuum chamber 18 (FIG. 1), gases and entrained ions are caused to flow through ion transfer tube 16 into the intermediate-vacuum chamber 18. The ion transfer tube may also serve as a counter-electrode for the API source so as to (in conjunction with another electrode at the source) initiate ion formation at the source—for instance, so as to form a Taylor cone in an ESI source or a plasma in an APCI source. The preferential flow of ions or other charged particles, relative to neutral gas molecules, into the ion transfer tube 16 is enhanced by an electrical potential difference applied between the API source 12 and the inlet end of the ion transfer tube, as schematically illustrated in box 40. A plate or second partition element or wall 15 separates the intermediate-vacuum chamber 18 from either the high-vacuum chamber 26 or possibly a second intermediate-pressure region (not shown), which is maintained at a pressure that is lower than that of chamber 18 but higher than that of high-vacuum chamber 26. Ion optical assembly or ion lens 20 provides an electric field that guides and focuses the ion stream leaving ion transfer tube 16 through an aperture 22 in the second partition element or wall 15 that may be an aperture of a skimmer 21. A second ion optical assembly or lens 24 may be provided so as to transfer or guide ions to the mass analyzer 28. The ion optical assemblies or lenses 20, 24 may comprise transfer elements, such as, for instance, multipole ion guides, so as to direct the ions through aperture 22 and into the mass analyzer 28. The mass analyzer 28 comprises one or more detectors 30 whose output can be displayed as a mass spectrum. Vacuum port 13 is used for evacuation of the intermediate-vacuum chamber and vacuum port 19 is used for evacuation of the high-vacuum chamber 26.

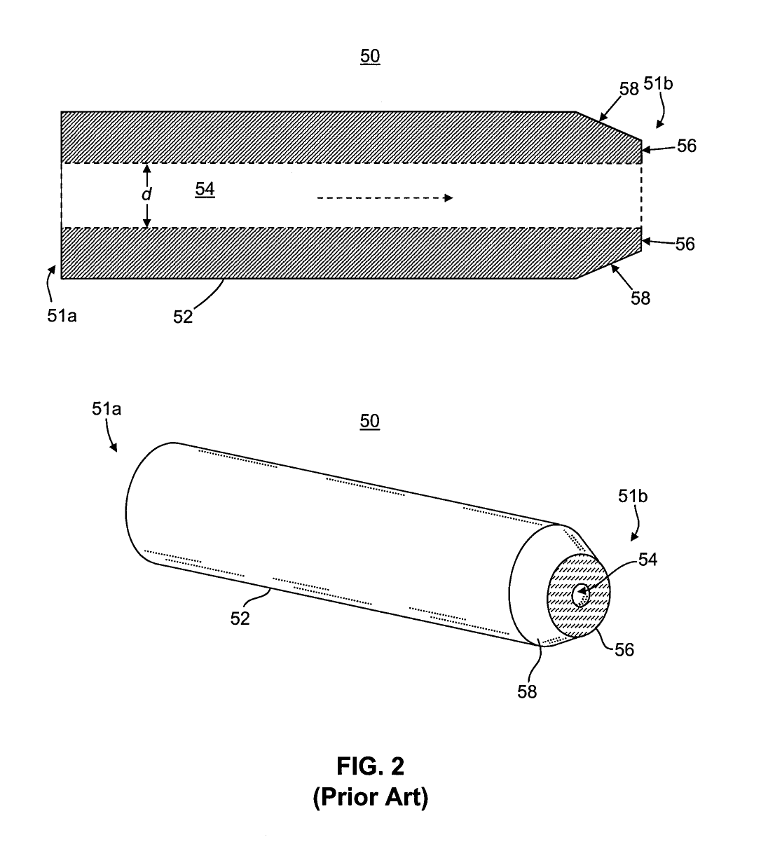

FIG. 2 is a schematic illustration of a conventional ion transfer tube 50. The upper and lower parts of FIG. 2 respectively show a cross-sectional view and a perspective view of the ion transfer tube 50. The ion transfer tube comprises a tube 52 (in this example, cylindrical tube) formed of a single structural member (for instance, glass or a metal) having a lumen or bore 54 through which gas and charged particles flow (as indicated by the dashed arrow) from an inlet end 51a to an outlet end 51b. Additional electrode members (not shown in FIG. 2) may be in contact with the tube 52 in order to maintain the tube at a given electrical potential (e.g., ground potential) or to provide an electrical potential gradient along the tube. If the tube 52 is formed of an electrical insulator material (e.g., glass), such electrodes may be applied as metal coatings on portions of the tube 52. At the outlet end 51b of the ion transfer tube, the tube 52 is terminated by a substantially flat end surface 56 that is substantially perpendicular to the length of the tube and to the flow direction. Further, a beveled surface or chamfer 58, which in the case of the cylindrical tube shown is a frustoconical surface, is disposed at an angle to the end surface so as to intersect both the end surface 56 and the outer cylindrical surface of the tube 52. The surface 58 may be used to align and seat the outlet end of the ion transfer tube against a mating structural element (not shown) in the interior of the intermediate vacuum chamber 18 or may be used so as to penetrate, upon insertion into a mass spectrometer instrument, a vacuum sealing element or valve, such as the sealing ball disclosed in U.S. Pat. No. 6,667,474, in the names of Abramson et al., said patent incorporated by reference herein in its entirety.

In a conventional mass spectrometer system, the API source 12 is maintained at approximately ground potential (denoted “Grnd.” in box 40 of FIG. 1) for safety considerations. Also, the internal electronics and components of the mass spectrometer are conventionally maintained at near-ground potential in order to avoid the requirement to “float” internal mass spectrometer electronics at high voltage together with its associated risk of electrical shorting or discharge. Nonetheless, a relatively high voltage difference is required between the API source 12 and the inlet end of the ion transfer tube 16 in order to create and accelerate ions and other charged particles into the tube and partially separate these from neutral particles or molecules. Consequently, in conventional systems, the charged particles traverse an electrical potential minimum (or maximum, depending upon the sign of the charge of the desired particles) along their path between the API source 12 and the internal ion optical components 20 as shown schematically by graphs 41-43 in box 40 of FIG. 1. These graphs assume that positively charged particles are produced by the ion source and delivered into the mass spectrometer apparatus. Graph 41 illustrates a hypothetical potential profile for a situation in which a single metal ion transfer tube is used and graph 42 illustrates a hypothetical profile in the case of a glass capillary having metalized ends. Graph 43 illustrates one possible profile for a situation such as described in U.S. Pat. No. 6,943,347 (inventors Willoughby et al.) in which the ion transfer tube is stratified or laminated and comprises alternating layers of insulating material and conducting electrodes, wherein voltages may be independently applied to the various conducting electrodes.

The ions or charged particles conventionally must traverse at least one region in which they move, under the influence of a carrier gas flow, against an electromotive force. However, in the laminated or stratified ion transfer tube described by Willoughby et al. (mentioned above), the charged particles may flow under the influence of an accelerating potential (that is, an electromotive force directed in the sense of ion motion) through at least a tube portion near the ion transfer tube inlet. The accelerating potentials are supplied to successive electrode layers of the laminated tube in order to eliminate external field penetration into the tube which would otherwise cause significant loss of charged particles at the inlet. Unfortunately, the ion transfer tube described by Willoughby et al. comprises multiple electrodes which require the provision of an appropriate power source or power divider as well as multiple electrical leads at the location of the ion transfer tube. Such requirements will, in general, not be compatible with existing apparatus.

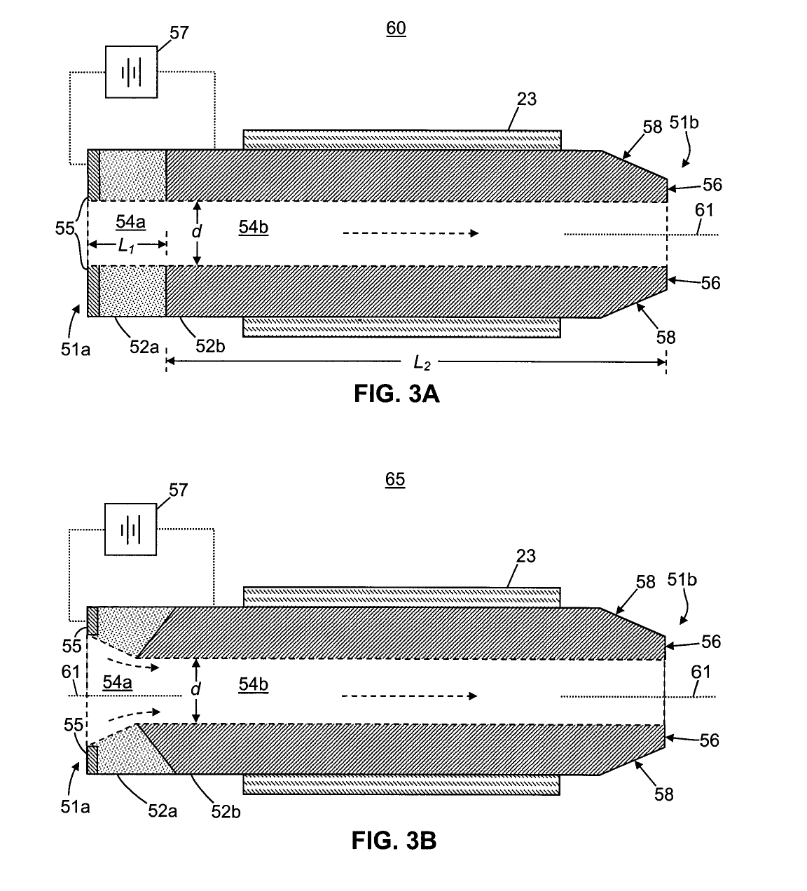

Accordingly, the inventors describe, in FIGS. 3-7 and the following associated discussion, ion transfer tube apparatus and methods that provide accelerating potentials at the inlet and that mitigate tube charging and dispersive electric fields at the inlet, but that do not require multiple electrical leads, thereby enabling simple substitution for existing conventional ion transfer tubes. FIG. 3A is a cross sectional view of a portion of an ion transfer tube, ion transfer tube 60, in accordance with various embodiments of the instant teachings. The reference numbers 51a, 51b, 56 and 58 in FIG. 3 are defined similarly to like elements in FIG. 2. In contrast to the conventional ion transfer tube illustrated in FIG. 2, the ion transfer tube 60 illustrated in FIG. 3 comprises two separate structural members—a first tube member 52a formed of an electrically resistive material and a second tube member 52b formed of a material, such as a metal, that is an electrical conductor and that also has high thermal conductivity. The two tube members 52a, 52b are joined to one another by a leak-tight seal between the two tube members. The diameter of the lumen or bore 54a of the first tube member 52a and the diameter of the lumen or bore 54b of the second tube member 52b are substantially identical to one another, the common bore diameter given as d.

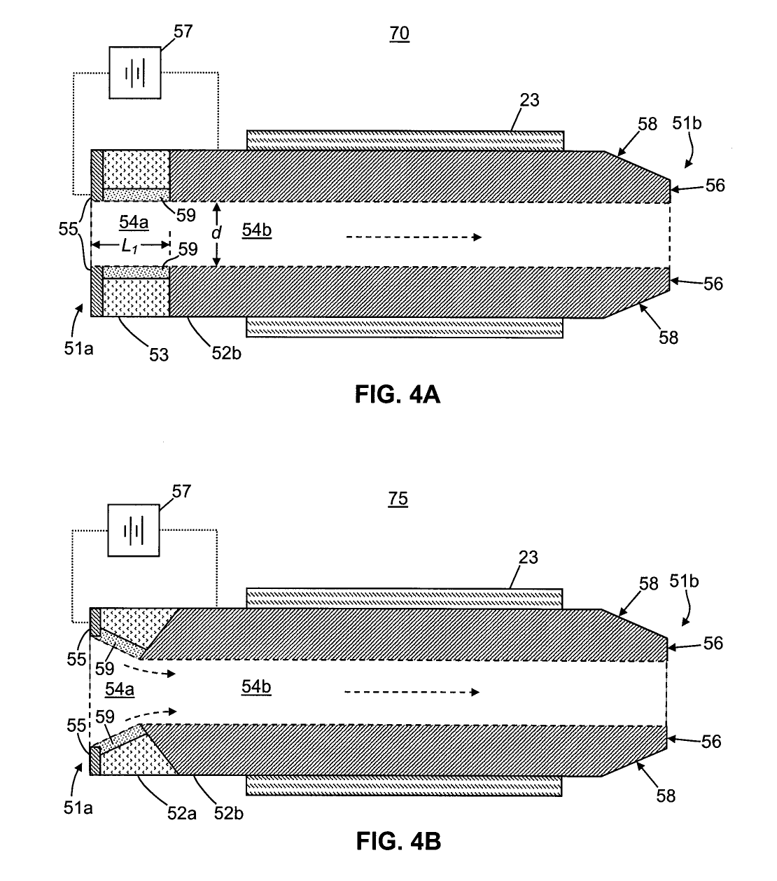

A dashed arrow in FIG. 3A indicates the direction of gas flow, together with entrained ions and possibly other charged particles, within the ion transfer tube 60. This flow is in the direction from the first tube member 52a to the second tube member 52b. Thus, the first tube member 52a and second tube member 52b are respectively disposed at the ion inlet end 51a and the ion outlet end 51b of the ion transfer tube 60. The distance from the open ion inlet of the tube 51a to the contact between the first and second tube members 52a, 52b is represented as a length L₁ which is greater than or equal to a flow transition length. The flow transition length is the distance within which the through-going flow of carrier gas changes from an initial plug flow or turbulent flow to laminar flow. Prior-art results have indicated that the minimum length for establishment of laminar flow is greater than or equal to approximately the lumen diameter. Although the distance L₁ is shown as encompassing both the length of the first tube member 52a and the thickness of the electrode 55 in FIG. 3A (and FIG. 4A), in many cases this distance may be substantially equal to the length of the first tube member 52a. The second tube member 52b has a length L₂.

The resistive tube member 52a may be formed of any one of a number of materials (e.g., without limitation, doped glasses, cermets, polymers, etc.) having electrically resistive properties. It has been postulated (see Verbeck et al., US Patent Application Publication 2006/0273251) that the use of a tube comprising a resistive material enables the bleeding off of any surface charge that would otherwise accumulate on an electrically insulating tube as a result of ion impingement on the tube surface. An electrode 55, which may be a plate, a foil, or a thin film coating, is in electrical contact with an end of the first tube member. A power supply 57 whose leads are electrically connected to the electrode 55 and to the second tube member 52b is operable so as to provide an electrical potential difference between an electrode 55 and to the second tube member 52b. Alternatively, the end of the first tube member 52a that faces the second tube member 52b may be provided with an electrode plate or film, such as a metalized coating together with a tab in electrical contact with the metalized coating. In such an instance, an electrical lead of the power supply 57 may be contacted to the tab, electrode plate or film, instead of directly to the second tube member. A heater 23 is in thermal contact with, preferably, the second tube member 52b and is operable to supply heat to the second tube member 52b and, consequently, to the gas and charged particles flowing through the lumen or bore 54b so as to de-solvate the particles. Alternatively, the heater may be in thermal contact with both the first tube member 52a and the second tube member 52b or with only the first tube member 52a, depending on the heating requirements of any particular application and the thermal conductivities of the materials used for the tube members.

As noted above, the length L₁ of the first tube member 52a should be at least as great as the distance required for the carrier gas flow to transition from an initial plug flow or turbulent flow to laminar flow. Within this flow-transition region, collisions of ions or other charged particles with the lumen wall are minimized by the axial electric field provided by the electrical potential difference between the electrode 55 and the second tube member 52b. Since the first tube member 52a is not an electrical insulator, those charged particles which may collide with the lumen wall do not cause surface charging of the first tube member and, thus, there is no opposing electrical field at the inlet end of the ion transfer tube 60 inhibiting the flow of charged particles into the tube. Once the ions or other charged particles have passed into the second tube member 52b, the laminar gas flow prevents further collisions with the lumen wall and, thus, a resistive tube material is no longer required. Instead, it is desirable to form the second tube member 52b of a sufficient length of a material with high thermal conductivity (such as a metal) such that ions are completely de-solvated by heat while traversing the second tube member 52b. This length required for desolvation, which may be on the order of several centimeters, may comprise a significant percentage of the space available for the ion transfer tube 60 within a mass spectrometer apparatus. Therefore, it may be desirable to limit the length L₁ of the first tube member 52a. The inventors have determined that adequate results are obtained when the length of the first tube member 52a (which may be substantially equal to L₁) is approximately 5 mm.

FIG. 3B is a cross sectional view of a portion of another ion transfer tube, ion transfer tube 65, which is a modified version of the ion transfer tube 60 of FIG. 3A in accordance with various embodiments of the instant teachings. As described supra with reference to the ion transfer tube 60 of FIG. 3A, the ion transfer tube 65 (FIG. 3B) comprises a first tube member 52a adjoined to a second tube member 52b by a leak-tight seal between the two tube members. However, in contrast to the previously discussed example, at least a portion of the lumen or bore 54a of the first tube member 52a of the ion transfer tube 65 is tapered from a larger diameter to a smaller diameter in the direction of ion and gas flow. In other words, at least a portion of the lumen or bore 54a of this tube comprises a portion of a conical surface which narrows from the ion inlet towards the junction with the second tube member 52b. The second tube member 52b has a lumen or bore 54b having a circular cross section with a substantially constant inner diameter d. At the junction between the first and second tube members 52a, 52b, the cross-sectional diameter of the lumen or bore 54a of the first tube member is also substantially equal to d.

The relatively larger diameter of the lumen or bore 54a of the first tube member 52a at the ion inlet end 51a serves to provide greater ion collection efficiency of ion transfer tube 65. Additionally, the junction between the first and second tube members 52a, 52b may be disposed, as illustrated in FIG. 3B at an angle that is not perpendicular to the long axis 61 of the lumen 54. This junction between the two tube members may be disposed such that the electric field lines that arise when an electrical potential difference is applied between the electrode 55 and the second tube member 52b have a component that serves to direct ions towards the axis 61 within the tapered lumen or bore 54a. These converging electric field components serve to counteract or nullify any dispersive electric fields that may penetrate into the ion inlet aperture from outside of the ion transfer tube.

The use of a resistive first tube member that is shorter than the entire length of the tube provides several benefits. Firstly, less voltage is required for the same electric field gradient over a shorter length. This provides for use of relatively inexpensive power supplies, safety shielding, and, in case of FAIMS or MS applications that employ helium gases, avoidance of Paschen breakdown at atmospheric pressure. Secondly, the lower voltage also has the benefit that adjacent ion lenses that would otherwise need to be maintained at a different potential relative to the entrance (or exit) of the ion transfer tube can be held at lower voltages.

Further, the material comprising the first tube member 52a (e.g. a resistive glass or a glass having a resistive coating, as discussed following) will generally be a poor conductor of heat whereas the electrically conductive material comprising the second tube member 52b (e.g. a metal) will generally be a good heat conductor. Normally, the ion transfer tube should be heated to facilitate desolvation of the ions contained in the solvent droplets flowing through the tube. The heat is carried away from the inside diameter of the tube by the flow of the approximately room temperature droplet-laden gas. (Note that the pressure gradient in the ion transfer tube could cause cooling of the gas below room temperature whereas heated gas flows in the atmospheric pressure ionization source could cause heating of the gas above room temperature). If this heat flux from the tube to the gas cannot be replenished in a timely fashion (because, for instance, of relatively poor conductivity of a long segment of a glass first tube member), this would cause its surface temperature to be lower than optimal for droplet desolvation and poor mass spectrometer instrument sensitivity would result. To counteract this effect, the exterior of the glass tube would need to be heated to a much larger temperature. Such additional heating could promote deterioration of the glass material of the tube, could lead to slower temperature response, or could cause other problems with thermal expansion of nearby components. Thus, relatively shorter first tube member segments are favored.

Even with the above-discussed considerations favoring a short length of the first tube member 52a, there is nonetheless a minimum length of the first tube member 52a required to preserve the benefit of the field gradient that prevents (or reduces) entrance loss—the length should be at least as long as the entrance length as known in fluid dynamics, which is the length required to develop (laminar) flow within the tube. After laminar flow has been established, there is no additional benefit to providing the resistive glass surface that provides the electric field gradient. The first tube member 52a will therefore generally have a length of approximately 5 mm. In general, it is desirable to employ a first tube member which is as short as possible, while still fulfilling the condition of the minimum length requirement.

FIGS. 4A-4B are cross sectional views of other ion transfer tubes in accordance with various embodiments of the instant teachings. As previously discussed with reference to the ion transfer tube 60 shown in FIG. 3A, each of the ion transfer tube 70 (FIG. 4A) and the ion transfer tube 75 (FIG. 4B) includes a first and a second tube member. The second tube members 52b of the ion transfer tubes 70, 75 are as previously described with reference to FIG. 3A and FIG. 3B, respectively. However, in contrast to the ion transfer tubes illustrated in FIG. 3, the first tube member 53 of each of the ion transfer tubes 70, 75 is formed of an electrical insulator material, such as glass. The lumen of each first tube member 53 is coated with a layer 59 of a resistive material. The ion transfer tube 75 (FIG. 4B) is a modification of the ion transfer tube 70 (FIG. 4A) which includes (as previously described in reference to FIG. 3B) a tapered bore 54a of the first structural member 53, a sloped junction between the first and second structural members, 53, 52b, or both.

Any bulk or film resistive material can be used as the material of the resistive layer 59 illustrated in FIG. 4. For example, the resistive material may comprise, without limitation, one or more of a resistive ink, such as a layer of carbon, cermet, polymer, etc., a metallic oxide, a doped glasses, a metal film, or a ferrite compound. Alternatively, if the first structural member 53 comprises a suitable metal or metal oxide containing glass, the resistive layer 59 may be formed, using a known technique, by chemical reduction of a surface of the first structural member 53. As discussed by Mordehai et al. (US Patent application 2008/0197275), this technique provides a chemically inert resistive surface in the inner bore of the tube without requiring a deposition step. Such resistive tubes are commercially available, e.g., under the name PHOTONIS FieldMaster™ Ion Guides/Drift Tubes from PHOTONIS USA of Sturbridge Mass. (USA). U.S. Pat. No. 7,081,618 in the name of inventor Laprade describes the manufacture of these commercially available tubes as including a reduction process, whereby a glass workpiece, such as a doped lead silicate glass workpiece, is annealed in a reducing hydrogen atmosphere. The reduction process can chemically modify the surface of the glass so as to convert a surface region of a highly insulating glass to a semiconducting surface layer, thereby enhancing conductivity. The use of ion transfer capillaries having resistive layers is also described in U.S. Pat. No. 5,736,740.

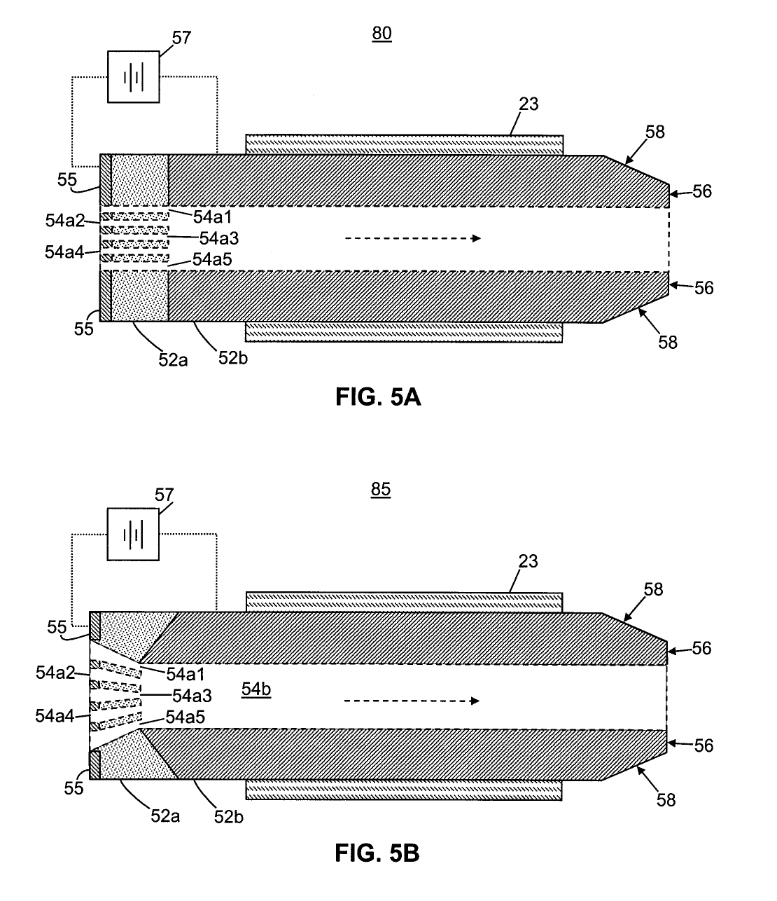

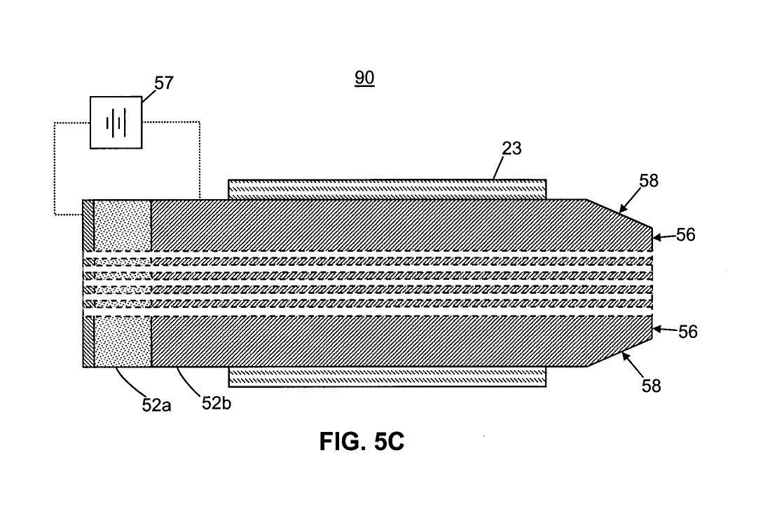

FIGS. 5A-5C are schematic cross sectional views of still other ion transfer tubes in accordance with various embodiments of the instant teachings. In the ion transfer tube 80 shown in FIG. 5A, the first tube member 52a comprises a plurality of bores, instead of the single lumen or bore already described herein. As a non-limiting example, FIG. 5A illustrates a first tube member having five separate internal bores, shown as bore 54a1, 54a2, 54a3, 54a4 and 54a5. These bores may comprise separate drilled (or alternatively fabricated) holes through the first tube member and may comprise any one of a wide variety of hole patterns in cross section.

The plurality of bores may be fluidically coupled to a plurality of emitters. In such an arrangement, each bore may receive charged particles from fewer than all of the emitters. Also, each bore may receive charged particles from more than one of the emitters. Because of varying coupling efficiencies, the percentage of the total charged-particle flux carried by each bore that is contributed by each the various emitters may vary between the bores. In a special case, each individual bore of the plurality of bores may be associated with or receive a flux of charged particles (ions or charged droplets) substantially from a respective one of a plurality of ion emitters, each ion emitter emitting ions from a respective portion of a total flow of sample or, alternatively, from a different respective sample. The actual degree or efficiency of fluidic coupling between each emitter and each bore may vary according to the geometric configuration of the emitters, the geometric configuration of the bores, the distance between the emitters and the ion transfer tube, variations in flow rates between emitters, as well as, possibly, other factors. As a result, each bore may not receive flux from all of the emitters. The plurality or array of emitters may be a component of an atmospheric pressure ionization (API) source. Examples of such arrays are disclosed in co-pending U.S. patent application Ser. No. 12/642,573 filed Dec. 18, 2009 titled “Apparatus and Methods for Pneumatically-Assisted Electrospray Emitter Array” and in a co-ending United States patent application titled “Multi-Needle Multi-Parallel Nanospray Ionization Source for Mass Spectrometry”, attorney docket number 5257US1/NAT, both of these applications assigned to the assignee of the instant application and incorporated by reference herein in their entirety. In the ion transfer tube 85 shown in FIG. 5A, the internal bores are not parallel to one another but, instead, converge towards one another in the direction of ion flow. This embodiment may be useful for enabling a large ion plume to be constricted down to the ion inlet diameter of the ion transfer tube. This embodiment may also be useful for interfacing a multi-emitter array to the ion transfer tube wherein, owing to geometric or mechanical considerations, the cross sectional profile of the plurality of emitters is greater than the ion inlet diameter.

It is well-known that, for electrospray ion sources, as the total flow rate per emitter decreases, the detected current per a given amount of analyte or per a given analyte concentration increases, thereby improving sensitivity. This result is attributed to the small bore of the electrospray emitter needles employed, which cause the diameter of the droplets formed at the Taylor cone to be the smallest, such that the combined effects of smaller initial droplet size and higher analyte concentration (as a result of less required solvent) permit a higher proportion of ions to be inlet into a mass spectrometer. Because the solvent is more readily evaporated from smaller droplets than from larger droplets, a decrease in flow rate per electrospray emitter enables the emitter to be placed closer to an ion inlet aperture (such as the ion inlet of an ion transfer tube) so as to capture a greater proportion of the spatially dispersed emitted plume of ions and droplets. When a total flow rate of sample is divided among a plurality of electrospray ion emitters, these advantages of low-flow-rate electrospray emission may be realized without the need to decrease the total sample flow rate.

In the ion transfer tube 85 shown in FIG. 5C, both the first and second tube members 52a, 52b have a plurality of internal bores, with each bore of the second tube member 52b aligned with and coupled to a respective one of the bores of the first tube member 52a. Each pair of associated bores (one bore in the first tube member and the associated mating bore in the second tube member) may transmit flux of charged particles (ions or charged droplets) from a respective one of a plurality of ion emitters, each ion emitter emitting ions from a respective portion of a total flow of sample. The plurality of bores in the heated second tube member 52b permit heat to be evenly and rapidly distributed to the full volume of sample within the ion transfer tube with minimal temperature gradient within the sample.

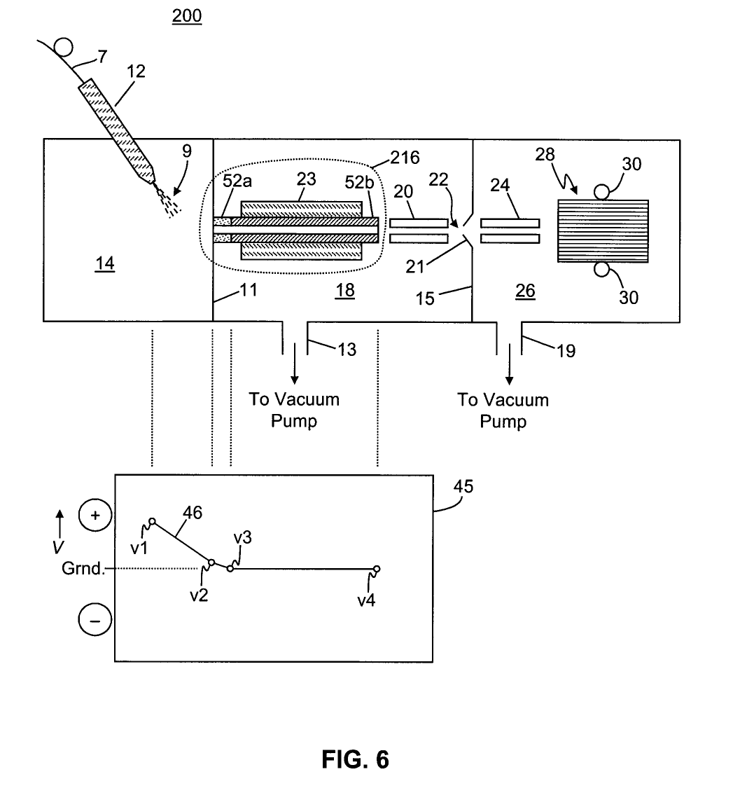

FIG. 6 is a schematic view of a mass spectrometer system in accordance with various embodiments of the instant teachings. In the mass spectrometer system 200 shown in FIG. 8, an ion transfer tube 216 in accordance with the instant teachings is employed in order to transfer ions entrained in a flowing background gas from an ionization chamber 14 to an intermediate vacuum chamber 18. Other reference numbers and features shown in FIG. 5 are similar to those shown and previously discussed with reference to FIG. 1. The ion transfer tube 216 may comprise any one of the ion transfer tubes 60-90 shown in FIGS. 3-5 or variations thereof. If one of the ion transfer tubes 80-90 is employed, then the API source may comprise a multi-emitter source, such that each is emitter is associated with a different one of the plurality of bores in either the first tube member 52a, the second tube member 52b, or both tube members. The mass analyzer 28 may include, and is not limited to a quadrupole mass analyzer, a time of flight (TOF) mass analyzer, a Fourier Transform mass analyzer, an ion trap, a magnetic sector mass analyzer or a hybrid mass analyzer.

Box 45 of FIG. 6 schematically illustrates a graph of an example electrical potential profile 46 along a portion of the path of charged particles through the apparatus 200. This graph assumes that positively charged particles are produced by the ion source 12 and delivered into the mass spectrometer apparatus. In contrast to the conventional situations (box 40 of FIG. 1), the apparatus utilizes an API ion source having a portion or component maintained at a high voltage, v1. Adequate electrical safety for users in the vicinity of the high-voltage ion source may be assured by provision of adequate physical encapsulation and isolation of the high voltage emitter, electrical shielding, ground-fault circuit interrupters, safety interlocks, and the like. Ions and other charged particles emitted from the API source 12 are accelerated or directed to the ion inlet of the first tube member 52a partially under the influence of a high voltage difference between the API source and the first tube member. Since the API source is maintained at high voltage, the ion inlet of the first tube member may be maintained at a voltage v2 at or near ground potential.

Still referring to box 45 of FIG. 6, the ions and other charged particles are further accelerated into the lumen of the first tube member by an accelerating potential difference (v2−v3), where v2 is the voltage applied to the second tube member 52b (or, equivalently, to the outlet end of the first tube member 52a). Because the first tube member 52a comprises a resistive material, an electromotive force oriented in the direction of the charged particle motion exists within the first tube member. Since the second tube member 52b is, preferably, formed of a metal, there is, in such a situation, no potential gradient along and no electric field within the second tube member. The electromotive force per unit charge is given by the electrical potential gradient. Because the length, L₁, of the first tube member is relatively short (e.g., less than or equal to 5 mm), an adequate potential gradient may be provided between the ends of the first tube member, even though the voltage difference (v2−v3), is relatively low. Typical values for the electrical potential gradient are in the range from 100 V-cm⁻¹ to 3000 V-cm⁻¹. Only two electrical leads to the ion transfer tube are required.

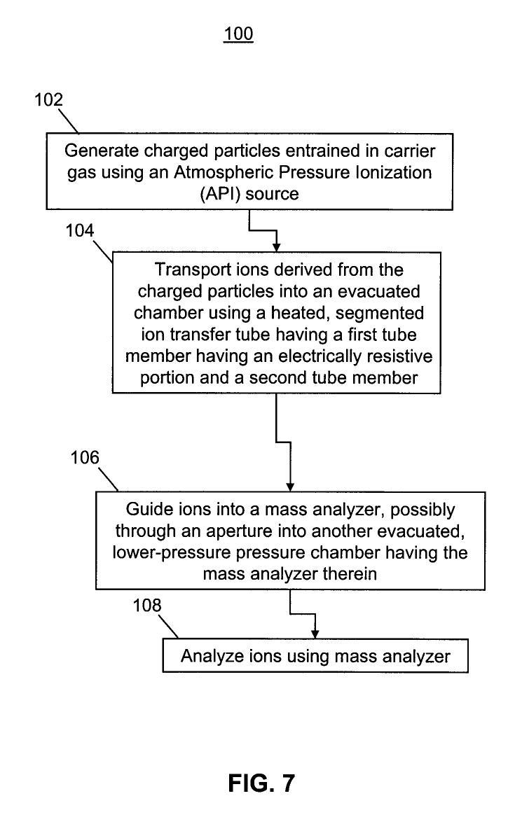

FIG. 7 is a flowchart of a method for analyzing ions in a mass spectrometer apparatus in accordance with the instant teachings. The first step, Step 102, in the method 100 comprises generating charged particles entrained in a carrier gas using an Atmospheric Pressure Ionization (API) source. Any known API source may be used, such as an electrospray ionization (ESI) source, a heated electrospray ionization (H-ESI) source, an atmospheric pressure chemical ionization (APCI) source, an atmospheric pressure matrix assisted laser desorption source, a photoionization source, or a source employing any other ionization technique that operates at pressures substantially above the operating pressure of a mass analyzer of the mass spectrometer apparatus. The charged particles may include free ions or charged droplets or a mixture both free ions and charged droplets. Further, the API source may comprise multiple emitters. In the next step, Step 104, ions derived from the charged particles in the carrier gas are transported into an evacuated chamber of the mass spectrometer using (or through) an ion transfer tube comprising at least two tube members—a first relatively shorter tube member at comprising a resistive material at the ion inlet and a second relatively longer conductive tube member at the ion outlet. Either or both of the tube members may be heated. Preferably, the second tube member comprises a thermally conductive material that is heated. The phrase “ions derived from the charged particles” refers to either the free ions initially generated by the API source or to ions liberated from charged droplets by solvent evaporation and de-solvation. As examples, the ion transfer tube may comprise any one of the illustrated ion transfer tubes 60-90 or variations thereof. In the next step, Step 106 of the method 100, at least a portion of the ions is guided, using ion lenses or other ion optics, or other ion optical assemblies, through an aperture into another evacuated, lower-pressure pressure chamber housing a mass analyzer. Finally, in Step 108, at least a portion of the ions are analyzed using the mass analyzer.

Apparatus and methods for improved ion transfer tubes are disclosed. These apparatuses and methods provide a unique combination of the entrance-loss-reducing benefit of a resistive tube member with the heat-conducting benefit of a conductive tube member. Various embodiments include multibore tubes for one or both of the members. The discussion included in this application is intended to serve as a basic description. Although the present invention has been described in accordance with the various embodiments shown and described, one of ordinary skill in the art will readily recognize that there could be variations to the embodiments and those variations would be within the spirit and scope of the present invention. The reader should be aware that the specific discussion may not explicitly describe all embodiments possible; many alternatives are implicit. Accordingly, many modifications may be made by one of ordinary skill in the art without departing from the spirit, scope and essence of the invention. Neither the description nor the terminology is intended to limit the scope of the invention. Any publications, patents or patent application publications mentioned in this specification are explicitly incorporated by reference in their respective entirety.

What is claimed is:

1. An ion transfer tube having an ion inlet and an ion outlet for a mass spectrometer, the ion transfer tube comprising:
(a) a first tube member comprising an electrically resistive material and having a first length and having first and second ends, the first end comprising the ion inlet;
(b) a first electrode electrically coupled to the first end of the first tube member;
(c) a second tube member having a second length greater than the first length and having a first end in leak-tight contact with the second end of the first tube member and a second end comprising the ion outlet;
(d) a second electrode electrically coupled to either the second end of the first tube member or the second tube member; and
(e) a heater thermally coupled to at least one of the tube members,
wherein, in operation, an electrical potential difference applied between the first and second electrodes produces an electric field within the first tube member that causes charged particles to be accelerated through the first tube member into the second tube member and the heater supplies heat to the charged particles within the ion transfer tube.

2. An ion transfer tube as recited in claim 1, wherein the first tube member comprises an electrically insulating tube having the electrically resistive material disposed in contact with a lumen or bore of the insulating tube.

3. An ion transfer tube as recited in claim 2, wherein the insulating tube comprises a glass.

4. An ion transfer tube as recited in claim 1 wherein the second tube member is formed of a metal.

5. An ion transfer tube as recited in claim 1, wherein the electric field within the first tube member comprises an axial field along a portion of the first tube member.

6. An ion transfer tube as recited in claim 1, wherein the first tube member comprises a plurality of bores through the first tube member.

7. An ion transfer tube as recited in claim 6, wherein the plurality of bores is fluidically coupled to a plurality of ion emitters.

8. An ion transfer tube as recited in claim 6, wherein each one of the plurality of bores receives charged particles substantially from a respective one of the plurality of ion emitters.

9. An ion transfer tube as recited in claim 6, wherein each one of the plurality of bores receives charged particles from more than one of but fewer than all of the plurality of ion emitters.

10. An ion transfer tube as recited in claim 6, wherein the second tube member comprises a plurality of bores through the second tube member, each of the plurality of bores through the second tube member aligned with a corresponding one of the plurality of bores through the first tube member.

11. An ion transfer tube as recited in claim 10, wherein each one of the plurality of bores of the first tube member is fluidically coupled to a respective ion emitter.

12. An ion transfer tube as recited in claim 1, wherein the heater thermally coupled to only the second tube member.

13. An ion transfer tube as recited in claim 1, wherein the heater thermally coupled to only the first tube member.

14. A method for analyzing ions in a mass spectrometer comprising:
(a) generating charged particles entrained in carrier gas using an Atmospheric Pressure Ionization (API) source;
(b) transporting ions derived from the charged particles through a first tube member having a first length and comprising an electrically resistive material, wherein the ions are at least partially accelerated through the first tube member by an electric field within the first tube member;
(c) transporting the ions derived from the charged particles into an evacuated chamber through a heated electrically conductive second tube member having a second length greater than the first length and in leak-tight contact with an end of the first tube member;
(d) guiding the ions to a mass analyzer; and
(e) analyzing the ions using the mass analyzer.

15. A method as recited in claim 14, wherein the step (b) of transporting the ions derived from the charged particles through the first tube member comprises transporting the ions through an electrically insulating tube having the electrically resistive material disposed in contact with a lumen or bore of the insulating tube.

16. A method as recited in claim 14, wherein the step (b) of transporting the ions derived from the charged particles through the first tube member comprises transporting the ions through a plurality of bores through the first tube member.

17. A method for analyzing ions in a mass spectrometer comprising:
(a) generating charged particles entrained in carrier gas using an Atmospheric Pressure Ionization (API) source;
(b) transporting ions derived from the charged particles through a heated first tube member having a first length and comprising an electrically resistive material, wherein the ions are at least partially accelerated through the first tube member by an electric field within the first tube member;
(c) transporting the ions derived from the charged particles into an evacuated chamber through an electrically conductive second tube member having a second length greater than the first length and in leak-tight contact with an end of the first tube member;
(d) guiding the ions to a mass analyzer; and
(e) analyzing the ions using the mass analyzer.

18. A method as recited in claim 17, wherein the step (b) of transporting the ions derived from the charged particles through the first tube member comprises transporting the ions through an electrically insulating tube having the electrically resistive material disposed in contact with a lumen or bore of the insulating tube.

19. A method as recited in claim 17, wherein the step (b) of transporting the ions derived from the charged particles through the first tube member comprises transporting the ions through a plurality of bores through the first tube member.
